(19) United States
(12) Patent Application Publication
(10) Pub. No.: US 2010/0058563 A1
(43) Pub. Date: Mar. 11, 2010

(54) Clamp Securement

(75) Inventor: Isa Col, Frankfurt (DE)

Correspondence Address: PRIEST & GOLDSTEIN PLLC, 5015 SOUTHPARK DRIVE, SUITE 230, DURHAM, NC, 27713-7736, US

(73) Assignee: Veritas AG, Gelnhausen (DE)

(21) Appl. No.: 12/551,616

(22) Filed: Sep. 1, 2009

(30) Foreign Application Priority Data
Sep. 11, 2008 (DE) 10 2008 046 893.2

(51) Int. Cl. F16L 33/02

(52) U.S. Cl. 24/279; 285/253

(57) ABSTRACT

The invention relates to a clamp securement (1) for a hose end of a hose with at least one holding element (3-5), wherein the holding element (3-5) includes a seating face (32, 70) for a hose clamp (2) as well as a plate (18, 19). Perpendicularly to this plate (18, 19) is disposed at least one engagement element (12-17) which is oriented in the direction of the hose. On the seating face is disposed a first pair of adjacent arms (20-25), which is located opposite a second pair of opposing arms (26-31). The arms (20-25; 26-31) are herein perpendicular on the seating face (32, 70) of holding element (3-5) and are oriented in the direction of the hose clamp (2). The first as well as also the second pair of arms (20-25; 26-31) include each a section which can be disposed over the hose clamp (2).

The invention relates to a clamp securement according to the preamble of patent claim 1.

Hose clamps serve for hose ends as holding devices, which are placed around the circumference of a hose in order to connect the hose end with a pipe connection over which the hose had been pulled beforehand. In order for the hose clamps not to become detached from the hose end, additional holding elements are frequently disposed on the hose clamp.

Known for a hose end is a holding device which includes a hose clamp which at least at one site includes a seizing part extending transversely to the circumference and engaging into the inside of the hose end (DE 103 24 236 A1).

Furthermore is known a clamp securement in which a clamp is connected with a holding element (U.S. Pat. No. 3,454,996; U.S. Pat. No. 3,477,106). The holding element is connected with the underside of the clamp and includes engagement elements with which the holding element can be connected with a hose end of a hose, such that the clamp can be securely located and secured in position on the hose.

The present invention addresses the problem of providing a clamp securement for a hose clamp which is developed such that a slipping of the hose clamp disposed on a hose is not possible.

This problem is resolved through the features of claim 1.

The invention relates to a clamp securement for a hose end with at least one holding element, wherein the holding element includes a seating face for a hose clamp as well as a plate. Perpendicularly to this plate is disposed at least one engagement element oriented in the direction of the hose. On the seating face is disposed a first pair of adjacent arms located opposite a second pair of opposing arms. The arms are herein disposed perpendicularly on the seating face of the holding element and face in the direction of the hose clamp. The first as well as also the second pair of arms have a section which can be disposed over the hose clamp.

By applying this clamp securement, widening of a hose end of the hose can be omitted, whereby high accuracy of the hose shape is attained. Placing the hose onto a connection, for example a pipe connection, consequently becomes very simple. Through this clamp securement costs can therefore be reduced since widening of the hose end is omitted.

Due to the method for applying the clamp securement, the hose clamp can further be disposed at a highly specific lock position on a hose. The exact axial position of the hose clamp can also be predetermined. In this manner, a clamp securement disposed on the hose can be obtained which is fixedly and securely disposed on the hose and can only be removed from same with difficulty.

Embodiment examples of the invention are depicted in the drawings and will be described in further detail in the following. In the drawing depict:

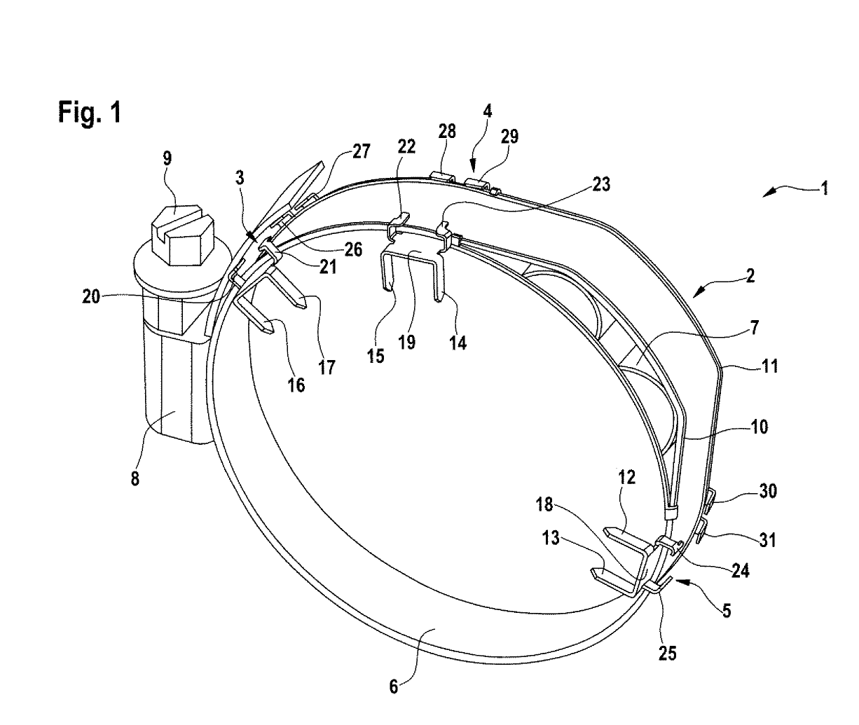

FIG. 1 a clamp securement without hose,

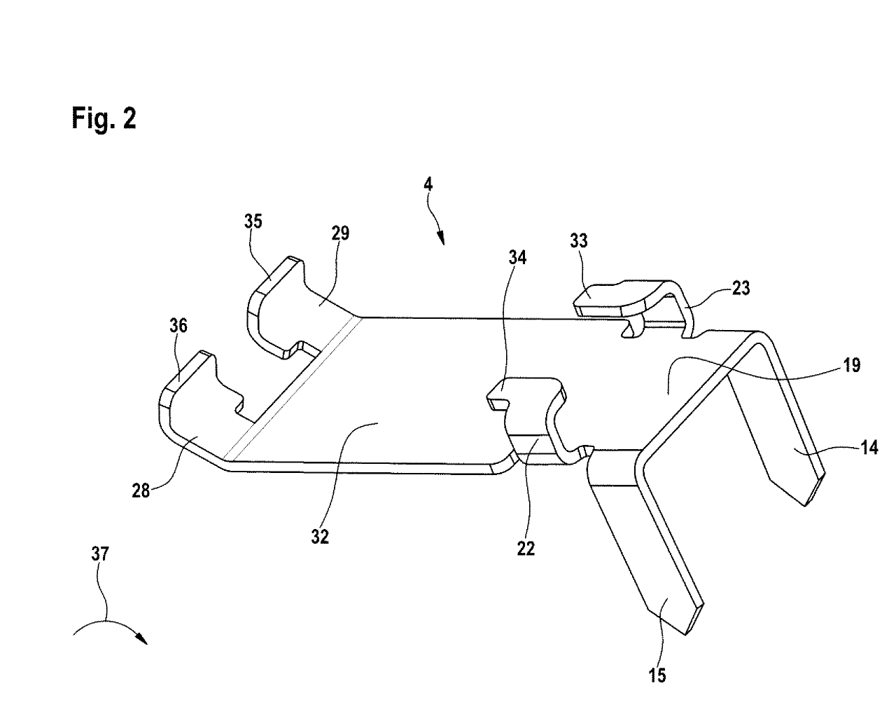

FIG. 2 a holding element of the clamp securement depicted in FIG. 1, without hose clamp,

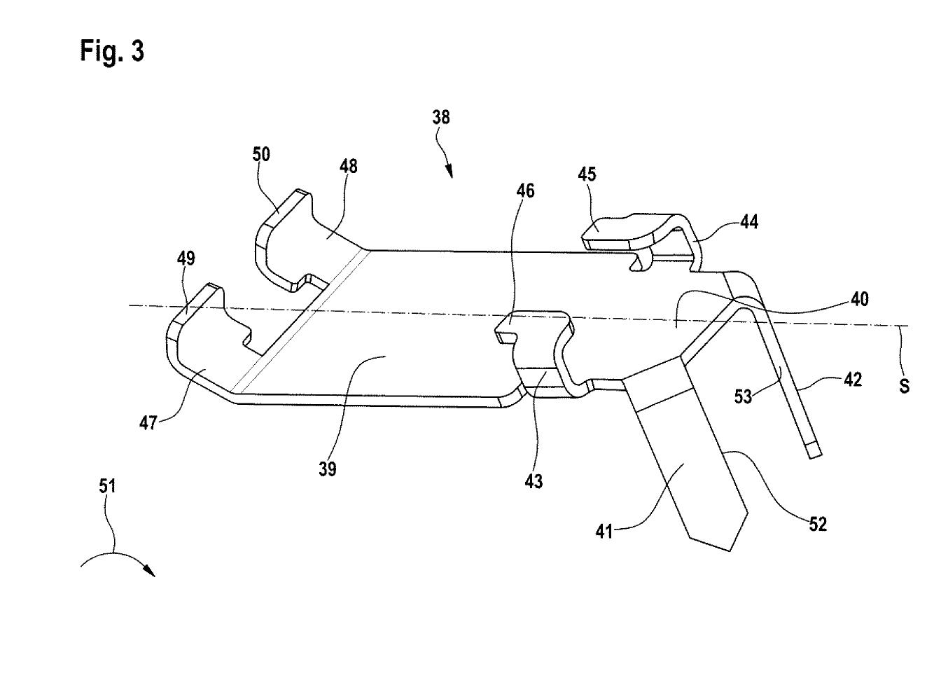

FIG. 3 a second variant of a holding element,

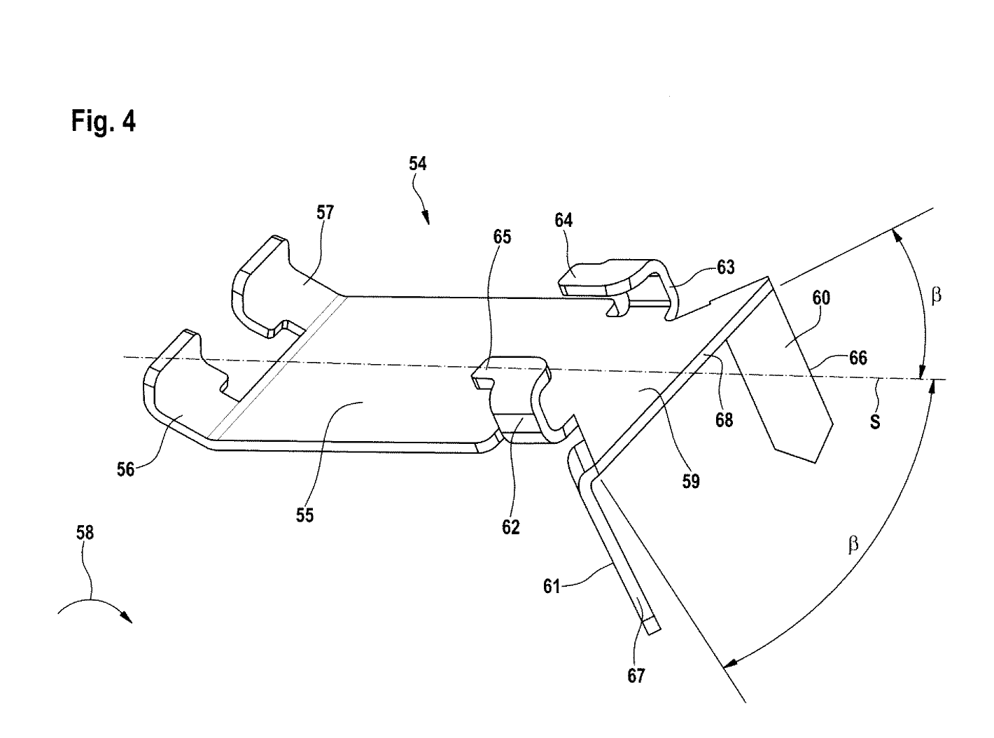

FIG. 4 a third variant of a holding element,

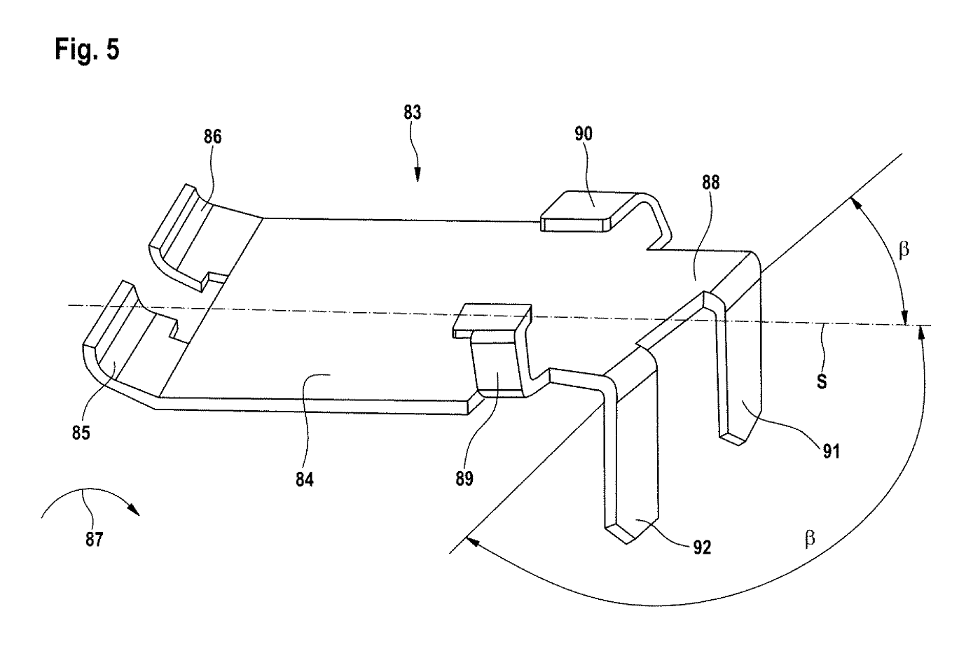

FIG. 5 a fourth variant of a holding element,

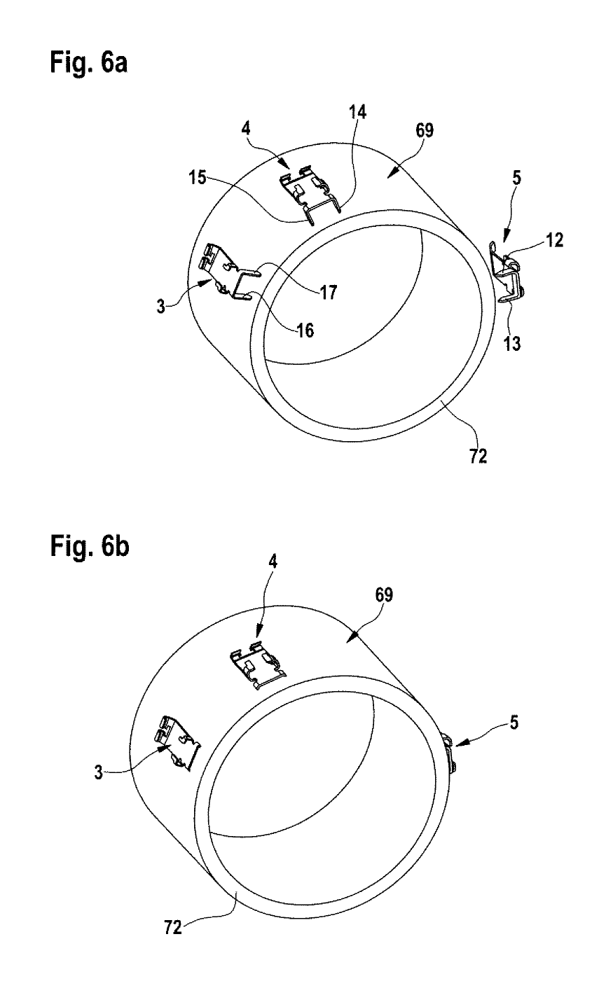

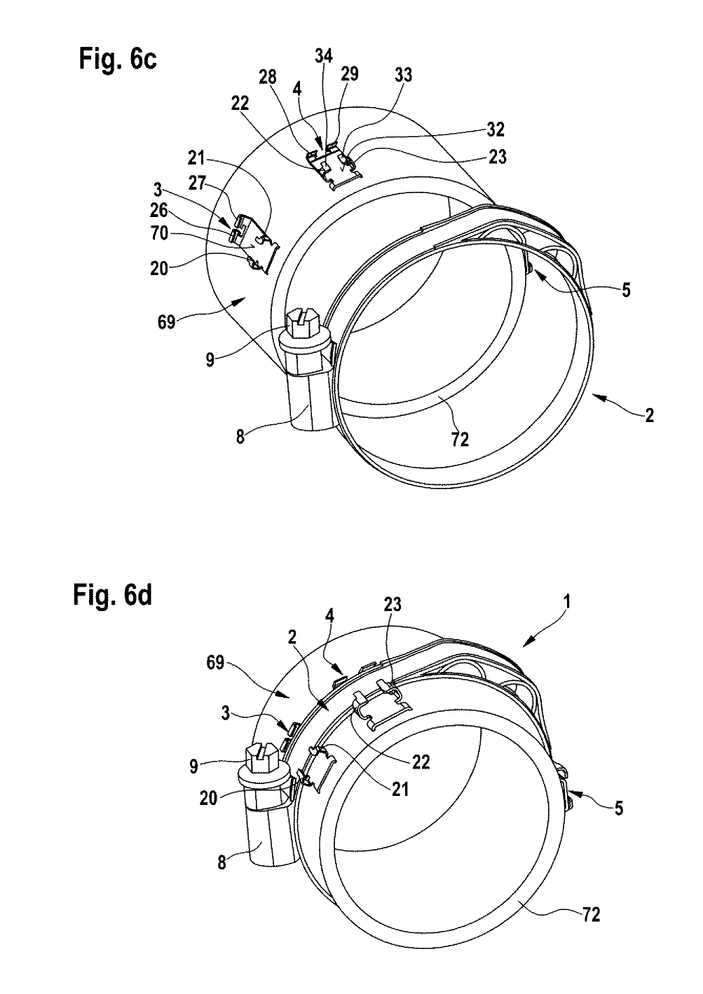

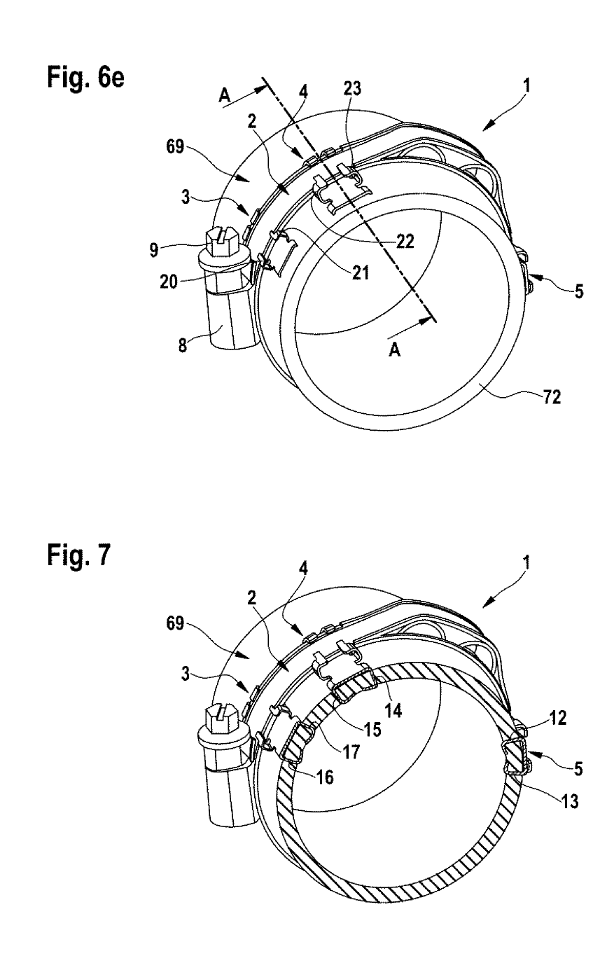

FIGS. 6a to 6e a method for applying the clamp securement according to FIG. 1,

FIG. 7 the clamp securement according to FIG. 6e, applied on a hose, after removal of a hose end,

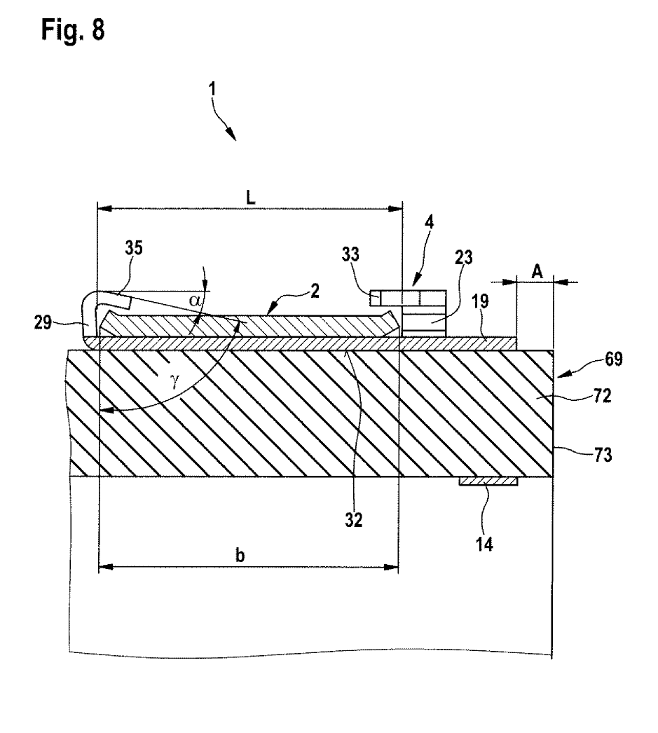

FIG. 8 a section through a portion of the clamp securement according to FIG. 6e, disposed on a hose,

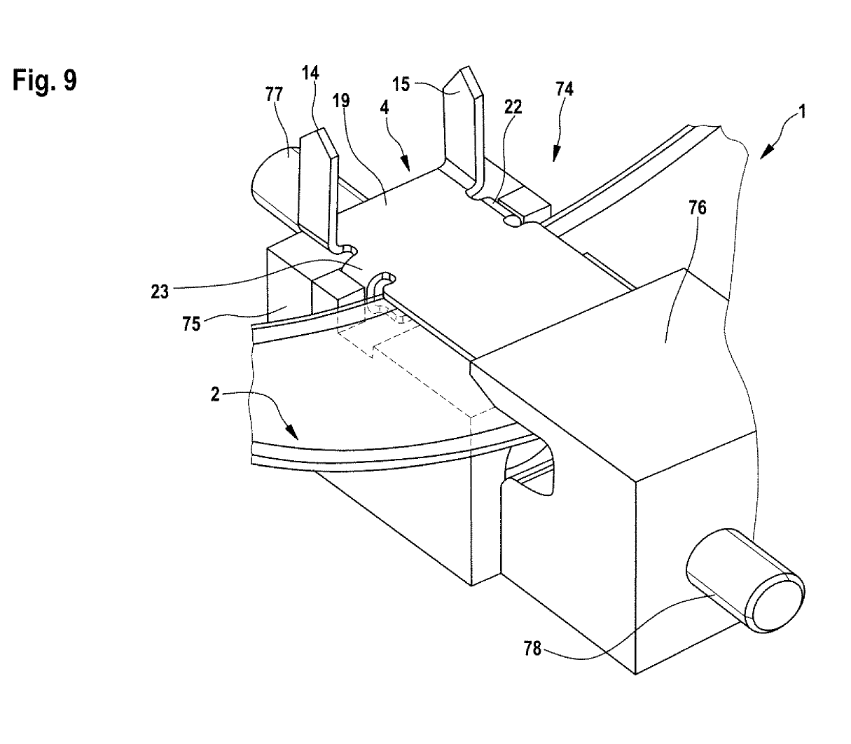

FIG. 9 a perspective view of a joining tool,

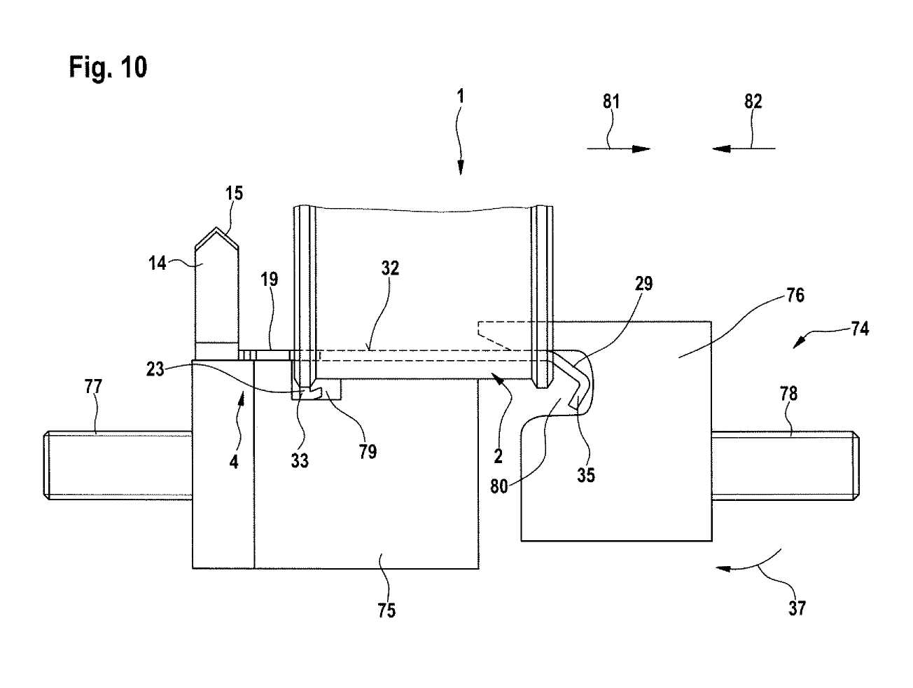

FIG. 10 a side view of a section of the joining tool shown in FIG. 9.

FIG. 1 shows a clamp securement 1 comprised of a hose clamp 2 as well as holding elements 3 to 5. The hose clamp 2 is a curved band 6 with integrated resilient insert 7. The hose clamp 2 comprises a bolt casing 8 with a bolt 9. With this bolt 9 the circumference of the band 6 can be varied. Evident are also elevations 10 and 11 disposed in the margin region of the band 6. The clamp securement 1 is here preferably comprised of a corrosion-resistant material, for example high-grade steel.

The holding elements 3 to 5 include at one of their ends two engagement elements each 12 to 17 which are located opposite one another. These engagement elements 12 to 17 are disposed perpendicularly on a plate of the particular holding elements 3 to 5. However, evident in FIG. 1 are only plates 18 and 19. Adjoining these plates 18, 19 is a seating face on which the hose clamp 2 rests. A seating face, however, is not evident in FIG. 1. As can be seen in FIG. 1, these engagement elements 12 to 17 are tapered at their end. However, it is also feasible that the engagement elements 12 to 17 do not taper at their ends but rather include shape edges. Although each of the holding elements 3 to 5 has two engagement elements 12 to 17, a holding element can also be provided with only one engagement element or also with more than two engagement elements.

The holding elements 3 to 5, further, have two opposing arms 20 to 25 each, which are disposed next to the two engagement elements 12 to 17 of each holding element 3 to 5. These arms 20 to 25 are also disposed perpendicularly on plates 18, 19. However, these arms 20 to 25 are directed in the opposite direction to the engagement elements 12 to 17. The arms 20 to 25 are substantially curved in the shape of a U and at least partially overlap the hose clamp 2. It can also be seen that each holding element 3 to 5 includes two further arms 26 to 31. These arms 26 to 31 are also bent at an angle and at least partially encompass the hose clamps 2.

FIG. 2 shows a holding element 4 of the clamp securement depicted in FIG. 1, without hose clamp. Plate 19, on which the engagement elements 14 and 15 are disposed, adjoins a seating face 32. The engagement elements 14, 15 are herein disposed perpendicularly on plate 19. In contact on this seating face 32 rests the hose clamp which is not shown in FIG. 1. Between plate 19 and the seating face 32 for a hose clamp are disposed two opposing, substantially U-shaped arms 22 and 23. Each of these arms 22, 23 has a section 33, 34 which at least partially overlaps seating face 32. Seating face 32 and sections 33, 34 are disposed substantially parallel to one another. Sections 33, 34 and seating face 32 are spaced apart from one another such that between these sections 33, 34 and the seating face 32 a hose clamp can be disposed. However, this is not shown in FIG. 2.

Evident are further the two arms 28, 29 which are also substantially U-shaped. Each of the two arms 28, 29 also includes a section 35, 36. These sections 35, 36 are each disposed over seating face 32 such that these two sections 35, 36 at least partially overlap the seating face 32. For this purpose, the two arms 28 and 29 must be bent at an angle, that is they must be moved in the direction of an arrow 37. However, this only takes place after a hose clamp has been placed on the seating face 32. FIG. 2, thus, shows the holding element 4 at a stage before a hose clamp is disposed on this holding element 4. As soon as sections 33 to 36 of arms 22, 23, 28, 29 are located over the hose clamp resting in contact on seating face 32, the hose clamp is disposed securely on seating face 32 of holding element 4.

FIG. 3 shows a second variant of a holding element 38 of the holding element 4 depicted in FIG. 2. Evident is again a seating face 39 connected with a plate 40. On this plate 40 are disposed two engagement elements 41, 42. These engagement elements 41 and 42 are disposed perpendicularly on plate 40 and extend in the direction of a hose, not shown in FIG. 3. Between plate 40 and seating face 39 are disposed two opposing, substantially U-shaped arms 43 and 44. These arms 43, 44 also include sections 45, 46, which at least partially overlap the seating face 39 and are disposed parallel to this seating face 39. Sections 45 and 46 are also spaced apart from seating face 39 such that between sections 45, 46 and seating face 39 a clamp, not depicted in FIG. 3, can be disposed.

On seating face 39 are further disposed two substantially U-shaped arms 47, 48, each of which includes a section 49, 50. However, these sections 49, 50 do not yet extend parallel to the seating face 39 of holding element 38, such that FIG. 3 also depicts a holding element at a stage before a hose clamp is placed on this seating face 39. The two arms 47, 48 have therefore not yet been moved in the direction of an arrow 51. The holding element 38, consequently, differs only from the holding element 4 by the different arrangement of the two engagement elements 41, 42. The two engagement elements 41, 42, have thus been moved with their two sides 52, 53 in the direction of an axis of symmetry S, such that these two sides 52, 53 of the engagement elements 41, 42 are now facing one another.

FIG. 4 shows a further variant of a holding element 54. The holding element 54 includes a seating face 55 with two arms 56, 57 disposed thereon. Since the arms 56, 57 have not yet been moved in the direction of an arrow 58, FIG. 4, consequently, depicts the holding element 54 before a hose clamp is applied. The holding element 54 includes a plate 59, on which two engagement elements 60, 61 are disposed. Between the plate 59 and the seating face 55 for a hose clamp are evident two substantially U-shaped arms 62, 63, each of which includes a section 64, 65. These sections 64, 65 are disposed substantially parallel to the seating face 55. Evident is that the engagement elements 60, 61 have sides 66, 67, which face away from one another, whereby the edge length of side 68 of plate 59 is extended with respect to plate 19 of holding element 4. The engagement elements 60, 61 are again disposed perpendicularly to plate 59 and face in the direction of a hose, not shown in FIG. 4. It is consequently advantageous that the engagement elements of a holding element are disposed perpendicularly to the particular plate. The engagement element 60 and the engagement element 61 form an angle β of 235° with respect to the axis of symmetry S.

FIG. 5 depicts a further variant of a holding element 83. This holding element 83 includes again a seating face 84 with two arms 85, 86 disposed thereon, which can be moved in the direction of arrow 87. Between a plate 88 and the seating face 84 are disposed two opposing arms 89, 90. The arms 85 and 89 as well as the arms 86 and 90 form guide sections. Two engagement elements 91, 92 are disposed on a plate 88 at an angle β of 90° with respect to the axis of symmetry S. The engagement elements 12 to 17; 41, 42; 60, 61 as well as 91, 92 are thus according to FIGS. 2 to 5 disposed at an angle of 90° to 235° measured from the axis of symmetry S. While an arrangement of these engagement elements at another angle to this axis of symmetry S is not shown in the Figures, it is, however, in principle conceivable.

FIGS. 6a to 6e shows a method for applying the clamp securement 1 according to FIG. 1 on one end 72 of a hose 69. In a first step the holding elements 3 to 5 are placed on the provided hose 69 thereby that the engagement elements 12 to 17 of holding elements 3 to 5 are inserted into hose 69 (cf. FIG. 6a). In FIG. 6b the holding elements 3 to 5 have already been placed onto the hose 69. After these holding elements 3 to 5 have been placed on hose 69, the engagement elements 12 to 17 located in hose 69 are bent out whereby the holding elements 3 to 5 are firmly and fixedly secured on hose 69. Bending the engagement elements 12 to 17 takes place by means of a joining tool which is not shown in FIGS. 6a to 6e. The hose clamp 2 is subsequently brought over the hose 69 and placed on the seating face of the holding elements 3 to 5 (cf. FIG. 6c). However, in FIG. 6c are only evident the seating faces 70, 32 of holding elements 3 and 4.

Evident in FIG. 6c is that the hose clamp 2 has a diameter only minimally greater than the diameter of the hose end 72. This is due to the fact that the hose clamp 2 only needs to be minimally widened in order to be placed on the holding elements 3 to 5. Of advantage is herein the position of arms 20, 26 as well as 21, 27 of holding element 3 and of arms 22, 28 as well as 23, 29 of holding element 4 with respect to one another. These opposing arms form each a guide section 20, 26; 21, 27; 22, 28; 23, 29; 85, 89; 86, 90. In these guide sections 20, 26; 21, 27; 22, 28; 23, 29; 85, 89; 86, 90 the hose clamp 2 can be disposed. Due to the defined distance of the seating faces from sections 33, 34, the hose clamp 2 can be placed on with a relatively small assembly diameter. The assembly diameter only needs to be minimally greater than the diameter of the hose end 72. Seating faces for the hose clamps, however, are not evident in FIG. 6c.

The method for applying the hose clamp 2 on the hose 69 thus becomes simple. If the hose clamp 2 is placed onto a hose in the engine compartment of a motor vehicle, this is possible without encountering problems in spite of the tight space availability.

FIG. 6d shows the manner in which the hose clamp 2 rests in contact on holding elements 3 to 5. The sections of the aims, however, are not yet located over the hose clamp 2. In FIG. 6c only arms 20 to 23 of holding elements 3 and 4 are evident. After the bolt 9 of hose clamp 2 has been tightened, the arms 20 to 23 can be moved in the direction of the hose clamp 2 such that the sections of arms 20 to 23 are disposed over the hose clamp 2. This state is shown in FIG. 6e. Bending the arms is carried out by means of a joining tool. However, such a joining tool is not depicted in FIG. 6e. In FIG. 6e the arms 20 to 23 rest against the hose clamp 2. The sections of arms 20 to 23 are located over the hose clamp 2.

A further advantage of this invention comprises that when disposing the hose clamp 2 on the seating faces of holding elements 3 to 5, only low friction is generated. The reason for this is the disposition of the arms of the holding elements 3 to 5. Through the arms of these holding elements 3 to 5 the hose clamp 2 can be guided precisely. If the bolt 9 of hose clamp 2 is to be tightened with a certain torque, the disposition of these arms prevents that the hose clamp 2 becomes canted. Holding elements 3 to 5, consequently, have not only the advantage that the hose clamp 2 is disposed firmly and securely on hose 69, but also that canting of the hose clamp 2 is prevented. Canting would have the consequence that, while an electronic screwdriver operating at a preset torque does switch off, however the hose clamp 2 will not yet be completely closed. Should a hose with a canted hose clamp be applied on a pipe connection, it would cause the hose to become very easily detached from the connection.

FIG. 7 depicts the state shown in FIG. 6e. The hose end 72 of hose 69, however, is cut away so that the engagement elements 12 to 17 of holding elements 3 to 5 can be recognized. The pointed ends of engagement elements 12 to 17 are facing one another. This state is attained thereby that the ends of engagement elements 12 to 17 are bent using a joining tool. For the sake of clarity, such joining tool is not shown in FIG. 6. Thereby that the ends of the engagement elements 12 to 17 face one another, the holding elements 3 to 5 are firmly and securely disposed on hose 69. The slipping of holding elements 3 to 5 is thus no longer possible. A user can also no longer injure himself on these pointed ends, since the pointed ends of the engagement elements 12 to 17 no longer project from the hose 69. This process of bending the pointed ends of the engagement elements 12 to 17 is also referred to as “crimping”.

FIG. 8 depicts a section A-A through a portion of the clamp securement 1 according to FIG. 6e disposed on hose 69. Shown is the holding element 4 which rests with its seating face 32 and plate 19 on hose 69. In contact on seating face 32 rests the hose clamp 2. The hose clamp 2 is encompassed on its sides by arm 23 and arm 29. Section 35 of arm 29 as well as section 33 of arm 23 at least partially overlap the hose clamp 2. The section 35 of arm 29 can herein be disposed parallel to the hose clamp 2 or, as is the case in FIG. 8, be bent out minimally in the direction of hose clamp 2. Consequently, section 35 does not extend parallel to hose clamp 2, but rather is bent at an angle α in the direction of the hose clamp 2. Angle γ, that is the angle between arm 29 and section 35, in this case is 90°−α which means γ≦90°.

It is advantageous if the two arms 29 and 23 have a spacing of length L which is only minimally greater than the width b of hose clamp 2. The spacing A between plate 19 and the end 73 of hose end 72 is maximally a few millimeters.

FIG. 9 shows a perspective view of a joining tool 74, with can be applied to bend the ends of engagement elements. The joining tool 74 is comprised of two jaws 75, 76, each of which includes threading 77, 78. These two jaws 75, 76 can be introduced into a joining tool via their threadings 77, 78. However, a joining tool is not depicted in FIG. 9. In contact on jaw 75 rests the hose clamp 2 with the holding element 4 disposed thereon. Hose clamp 2 and holding element 4 thus form a component of the clamp securement 1. The clamp securement 1 rests in contact on a hose, not shown here. Evident are the engagement elements 14, 15 of holding element 4, which are disposed perpendicularly on plate 19.

In FIG. 10 is depicted a side view of the joining tool 74 shown in FIG. 9. Evident are the two jaws 75, 76 on which the clamp securement 1 is disposed. The hose is also omitted in FIG. 10 for the sake of clarity. Seen can be again the two engagement elements 14, 15, which are disposed perpendicularly on plate 19. Shown is further arm 23, which is introduced in a notch 79 of jaw 75 whereby the section 33 of arm 23 is also disposed in notch 79. While plate 19 of holding element 4 is disposed directly on jaw 75, seating face 32 is not directly in contact with jaw 75. Since the seating face 32 is overlapped by the hose clamp 2, the seating face 32 is only shown schematically. Between seating face 32 and jaw 75 is disposed the hose clamp 2 such that here the hose clamp 2 rests directly on jaw 75. Arm 29 with section 35 is disposed in a basin 80 of jaw 76. If the two jaws 75, 76 are now moved toward one another, i.e. if jaw 75 is moved in the direction of arrow 81 and jaw 76 in the direction of arrow 82, arm 29 is thereby moved in the direction of arrow 37. Arm 28 is also moved in the direction of arrow 37. However, since arm 28 is located behind arm 29, arm 28 is not visible in FIG. 10. By moving the two jaws 75, 76 toward one another, the sections of arms 28, 29 come to be disposed over hose clamp 2. Arms 28, 29 of holding element 4 thereby encompass at least partially the hose clamp 2. In FIG. 10, however, only arm 29 with its section 35 can be seen.

One advantage of this clamp securement 1 with holding elements 3 to 5 comprises in particular that the assembly time is considerably reduced, whereby costs are also reduced. Holding elements and hose clamp can be comprised of different materials. Thereby that the holding elements 3 to 5 are applied on hose 69 using a tool and the ends of the engagement elements 12 to 17 of holding elements 3 to 5 are bent, the holding elements 3 to 5 are disposed firmly and securely on the hose 69. It is also advantageous that the holding elements 3 to 5 include arms 26 to 31 as well as 20 to 25, which at least partially encompass the hose clamp 2. The hose clamp 2 is thereby firmly and securely disposed in the holding elements 3 to 5. Of advantage is herein that the arms 26 to 31 are bent only after the hose clamp 2 is already disposed on the holding elements 3 to 5. This contributes significantly to the clamp securement 1 being disposed firmly and securely on hose 69. It is understood that, instead of three holding elements 3 to 5, fewer or more than three holding elements can also be utilized for such a clamp securement. Preferred are however more than two holding elements for one clamp securement. The clamp securement 1 can thereby not be removed as easily from the hose end 72. Tilting or canting of the hose clamp 2 is thereby also avoided.

Advantageous is herein that this clamp securement 1 is disposed very firmly and securely on hose 69. The holding forces of this clamp securement 1 are therewith much greater than is the case in conventional clamp securements. Holding forces of this order of magnitude can only be attained with conventional clamp securements using higher tightening torques. However, higher tightening torques are undesirable since the hose can thereby be damaged.

This clamp securement can be utilized for hoses of different diameters. Hose clamps of different size can also be utilized for the clamp securement.

A further advantage of these freely positionable holding elements comprises further that the clamp securement can be utilized for different connection types, that means, for example, also for motor vehicles of different type.

1. Clamp securement (1) for a hose end (72) of a hose (69) with at least one holding element (3-5, 38, 54, 83), wherein the holding element (3-5) includes a seating face (32, 39, 55, 70, 84) for a hose clamp (2) as well as a plate (18, 19, 40, 59, 88), wherein on the plate at least one engagement element (12-17, 41, 42, 60, 61, 91, 92) is disposed perpendicularly to this plate (18, 19, 40, 59, 88) and facing in the direction of the hose (69), characterized in that on the seating face (32, 39, 55, 70, 84) a first pair of adjacent arms (20-25, 49, 50, 56, 57, 85, 86) is disposed which is located opposite a second pair of opposing arms (26-31, 43, 44, 62, 63, 89, 90), wherein the arms of the first and of the second pair (20-25, 49, 50, 56, 57, 85, 86, 26 to 31, 43, 44, 62, 63, 89, 90) are disposed perpendicularly on the seating face (32, 39, 55, 70, 84) and facing in the direction of the hose clamp (2), and wherein the engagement elements (12-17, 41, 42, 60, 61, 91, 92) form an angle β of 90° to 235° with respect to an axis of symmetry S extending through the holding elements (3-5, 38, 54, 83).

2. Clamp securement (1) as claimed in claim 1, characterized in that the arms (20, 26; 23, 27; 22, 28; 23, 29; 85, 89; 86, 90) form guide sections (20, 26; 23, 27; 22, 28; 23, 29; 85, 89; 86, 90).

3. Clamp securement (1) as claimed in claim 2, characterized in that the hose clamp (2) is disposed between the guide sections (20, 26; 23, 27; 22, 28; 23, 29; 85, 89; 86, 90).

4. Clamp securement (1) as claimed in claim 1, characterized in that the arms (22, 23, 43, 44, 62, 63) include sections (33, 34, 45, 46, 64, 65), wherein sections (33, 34, 45, 46, 64, 65) are disposed parallel to the seating faces (32, 39, 55, 70, 84) and at least partially encompass the hose clamp (2).

5. Clamp securement (1) as claimed in claim 1, characterized in that the arms (28, 29, 47, 48, 56, 57, 85, 86) include sections (35, 36, 49, 50), wherein the sections (35, 36, 49, 50) in a first state are not oriented parallel to the seating faces (32, 39, 55, 70, 84) and in a second state are disposed substantially parallel to the seating faces (32, 39, 55, 70, 84) and thereby at least partially encompass the hose clamp (2).

6. Clamp securement (1) as claimed in claim 5, characterized in that the angle γ formed between the arms (28, 29, 47, 48, 56, 57, 85, 86) and the sections (35, 36, 49, 50) assumes values of γ≦90°.

7. Clamp securement (1) as claimed in claim 1, characterized in that the arms (20, 26; 23, 27; 22, 28; 23, 29; 85, 89; 86, 90) of the guide sections (20, 26; 23, 27; 22, 28; 23, 29; 85, 89; 86, 90) have a spacing of length L which is greater than the width b of the hose clamp (2).

8. Clamp securement (1) as claimed in claim 1, characterized in that the engagement elements (12-17, 41, 42, 60, 61, 91, 92) engage into the hose end (72) of the hose (69).

9. Method for applying a clamp securement (1) on a hose (69), comprising the following steps:
a) providing the hose (69) and at least one holding element (3-5);
b) applying the holding elements (3-5, 38, 54, 83) on the hose (69);
c) bending the engagement elements (12-17, 41, 42, 60, 61, 91, 92);
d) placing a hose clamp (2) onto the holding elements (3-5, 38, 54, 83);
e) by means of a joining tool (74) the arms (26-31, 43, 44, 62, 63, 89, 90) are bent such that these arms (26-31, 43, 44, 62, 63, 89, 90) at least partially also encompass the hose clamp (2).

10. Method as claimed in claim 9, characterized in that in step b) the at least one holding element (3-5, 38, 54, 83) with its engagement elements (12-17, 41, 42, 60, 61, 91, 92) engages into a hose end (72) of the hose (69).

11. Method as claimed in claim 9, characterized in that the engagement elements (12-17, 41, 42, 60, 61, 91, 92) are bent by means of a joining tool.

12. Method as claimed in claim 9, characterized in that the hose clamp (2) is disposed on a seating face (32, 39, 55, 70, 84) of the corresponding holding element (3-5, 38, 54, 83).

13. Method as claimed in claim 9, characterized in that the arms (26-31, 47, 48, 56, 57, 85, 86) are bent by means of a joining tool (74).

14. Method as claimed in claim 9, characterized in that before step e) the hose clamp (2) is tightened via a bolt (9) disposed on the hose clamp (2).
